(19) United States
(12) Patent Application Publication
(10) Pub. No.: US 2007/0160226 A1
(43) Pub. Date: Jul. 12, 2007

(54) Method and system for providing a selectable audio signal

(75) Inventors: Arlen Hestel Carpenter, Garner, NC (US); Joseph Daniel Souders, Garner, NC (US); Raymond John Roberge, Knoxville, TN (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: Antler Enterprises, Inc., Garner, NC (US)

(21) Appl. No.: 11/649,133

(22) Filed: Jan. 3, 2007

Related U.S. Application Data
(60) Provisional application No. 60/757,098, filed on Jan. 6, 2006.

(51) Int. Cl. H04B 1/00

(52) U.S. Cl. 381/86

(57) ABSTRACT

This device is an add-on component to an existing keyless entry system that will play a pre-recorded sound from a speaker/amplifier system mounted underneath the hood of a motor vehicle. Installable interchangeable sound cards are provided to give the device the ability to play different sounds. A digital sound amplifier is activated by the radio frequency of the automobiles factory installed keyless entry system. This is a novelty item and does not interfere with the cars existing systems.

### CROSS REFERENCE TO RELATED APPLICATION

This application is related to and claims priority to Provisional Application Ser. No. 60/757,098 filed Jan. 6, 2006, and to the filing date thereof, entitled “Method and System for Providing a Selectable Audio Signal”. The disclosure of said provisional application is incorporated by reference herein in its entirety.

### BACKGROUND OF THE INVENTION

1. Field of the Invention

This invention relates to audio signaling devices, and more precisely to audio signaling devices to be used with conventional remote Radio Frequency (RF) controlled locking/unlocking systems currently installed in most motor vehicles.

2. Discussion of the Prior Art

Most new automobiles are factory equipped with remote RF controlled devices for locking and unlocking the vehicles' doors. These keyless entry systems employ a radio frequency signal to activate the system. To engage the system, an operator simply pushes a button on his key fob. This sends out a radio signal that will either lock or unlock the doors.

On most motor vehicles, when the operator locks or unlocks the doors, the lights and/or horn also operate, to help the driver know that his doors are locked or unlocked. The sound of the vehicles' horn provides feedback to the operator that the system has been activated. The sounding of the horn can also assist the driver in finding his vehicle, when he is in a crowded area.

Most motor vehicle horns all sound somewhat similar. If two operators are simultaneously using their system, the drivers may get confused as to the correct location of their motor vehicle. This confusion may also occur when the driver is locking the car, and another operator is also locking their car at the same time.

One system that attempts to overcome some of these limitations is disclosed in U.S. Patent Application Publication No. US 2005/0110619 A1. The system described therein discloses a system for a vehicle remote control locking/unlocking mechanism that is more intricate than a horn or beep tone. The system provides a complex arrangement of connectivity to, for example, an MP3 player or from an internet website. An MP3 player can be connected to download sounds into digital audio storage or it can have a complex wired or wireless internet connection. In all cases, except for the simplest production of a rhythmic pattern, the system contemplates payment of royalties to the owners of the complex sounds which are downloaded, and which are described as recorded sounds obtained with permission from copyright owners.

As may be appreciated, the installation of a digital audio storage with consequent complex connectivity to an MP3 player, CD, DVD and wired or wireless internet is complex and cumbersome. In addition, depending on the source of sound selected, the payments required as royalties further complicate its' use and implementation.

In accordance with the invention described herein, these and other disadvantages of existing prior art systems are avoided.

### BRIEF SUMMARY OF THE INVENTION

In one aspect, the invention relates to an audio signaling device. The audio signaling device includes a loud speaker and amplifier mountable and connectable to a vehicle's remote locking system. A digital audio storage unit is connected to the loud speaker and amplifier. The digital audio storage unit has a replaceable storage module with at least one pre-recorded sound stored thereon. The predetermined sound is different from the sound emitted by a vehicle's remote locking system. Interrupt means, namely specifically designed circuitry, is part of the digital audio storage unit for preventing play of a vehicle's original sound associated with its remote locking system when activated and ensuring play of at least one pre-recorded sound different from the original vehicle sound.

In one specific aspect, the digital audio storage unit is also connectable to a vehicle's lighting system for causing a vehicle's lights to flash when the vehicle's remote locking system is actuated. Further, the digital audio storage unit includes a removable sound card having a puerility of sounds stored thereon, and further comprising selecting means, namely, also part of the circuitry as designed, for selecting a desired sound to play when a vehicle's remote locking system is actuated. Yet still further, the sound card is programmable for adding or removing sounds stored thereon.

In accordance with the invention, if the operator can choose from a bank of pre-recorded sound cards, which help distinguish their vehicle from the crowd, it not only helps them locate their motor vehicle, but can also be personalized to reflect aspects of particular importance to them. The use of sound cards is simpler, and does not require the complex arrangement of storage and input means described previously.

Examples of sounds in the cards include, but are not limited to, wildlife calls to show others their love for the great outdoors; saying a team name to show support for their favorite team; their favorite sayings, etc. These unique sounds allow the owner's vehicle to stand out as being different. These sounds are not limited to only the items discussed in this application.

In accordance with the present invention, a system is provided for a vehicle remote control/keyless locking system that provides an audio signal that is more complex than a simple sounding of the vehicle's horn. The system includes a digital audio source with a signal amplifier and a loudspeaker. The digital audio source is able to produce a variety of sounds by employing a single plug-in sound card.

The digital audio sounds can be interchanged by purchasing different sound cards. These may contain animal sounds, popular phrases, or clips from movies.

### BRIEF DESCRIPTION OF THE SEVERAL VIEWS OF THE DRAWING

Having thus briefly described the invention, the same will become better understood from the following detailed description, made with reference to the appended drawings, in which:

FIG. 1 is a block diagram illustrating how the system of the invention may be implemented in most vehicle remote control locking mechanisms; and (16) FIGS. 2 and 3 are circuit diagrams which when viewed together make up a digital audio storage unit.

### DETAILED DESCRIPTION OF THE INVENTION

The system includes a loudspeaker/amplifier system that is mountable in a discreet location. Such a location may include, but is not limited to, under the hood of a motor vehicle. The system has a wiring harness that hooks into the existing vehicle's remote locking system. This wiring harness is complete with all required electrical protection to protect the system, as well as the motor vehicle.

The speaker/amplifier system is preferably in a weatherproof enclosure, to offer protection from weather and other natural elements.

The speaker/amplifier system includes digital audio storage built into the unit. This storage will have pre-recorded sounds, contained in a replaceable sound card or chip, that is transmitted to the amplifier, and then to the loudspeaker. This unit is as small as possible, only limited by manufacturing constraints. Because a loudspeaker can produce complex sounds, there will be an unlimited amount of sounds that could be used in the device and system.

Individuals with basic mechanical/electrical abilities can complete the installation of the invention. The system will be operated by the vehicle's existing remote keyless entry system (RKES), requiring no additional key fob to be carried by the operator.

The present invention can provide a limitless supply of pre-recorded sounds that can be selected according to each operator's preference in a simple and easy to install manner. These sounds will not only allow the operator to personalize his motor vehicle, but will also be the source of amusement for the operator, as well as others that hear these sounds.

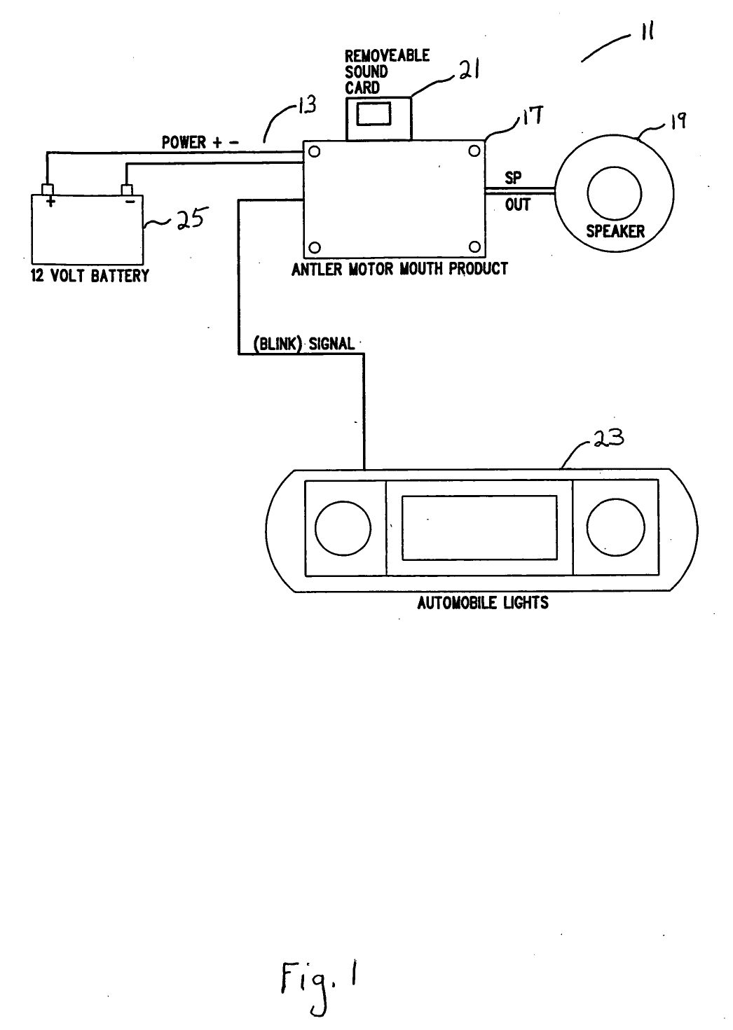

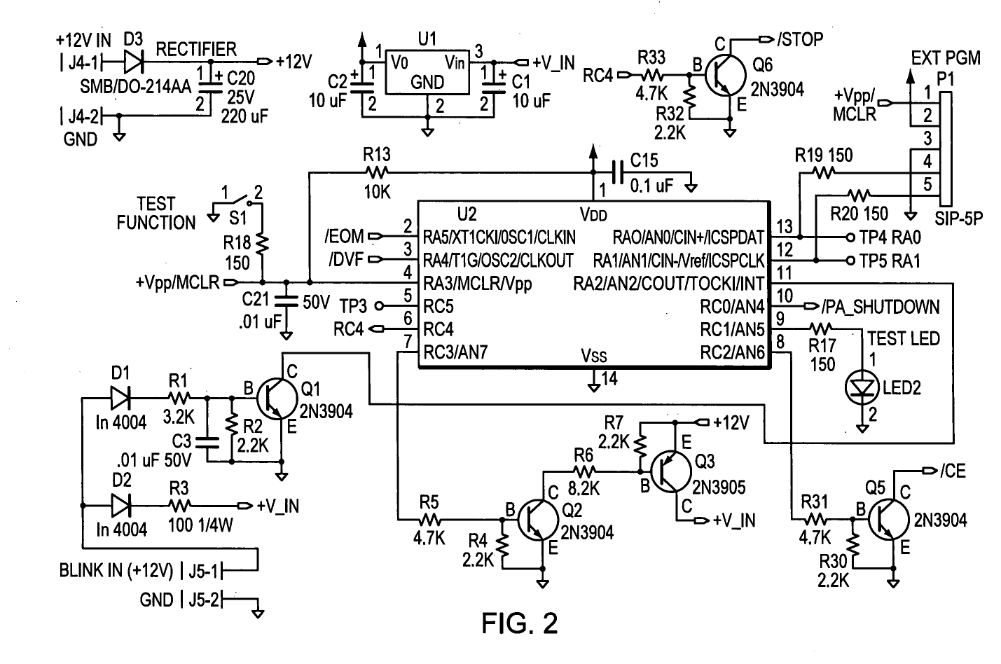

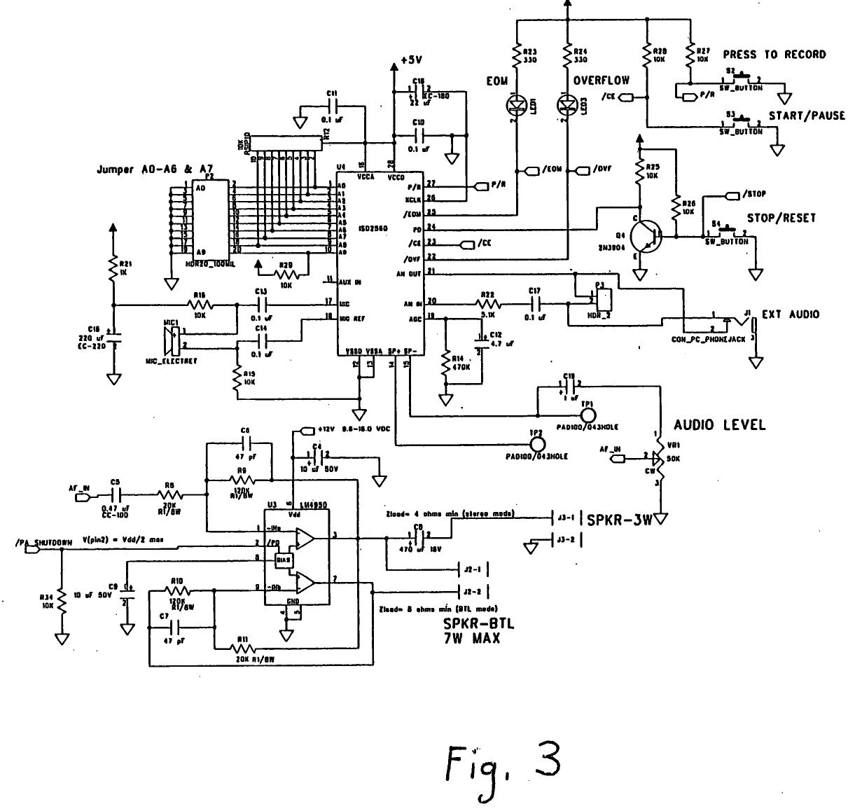

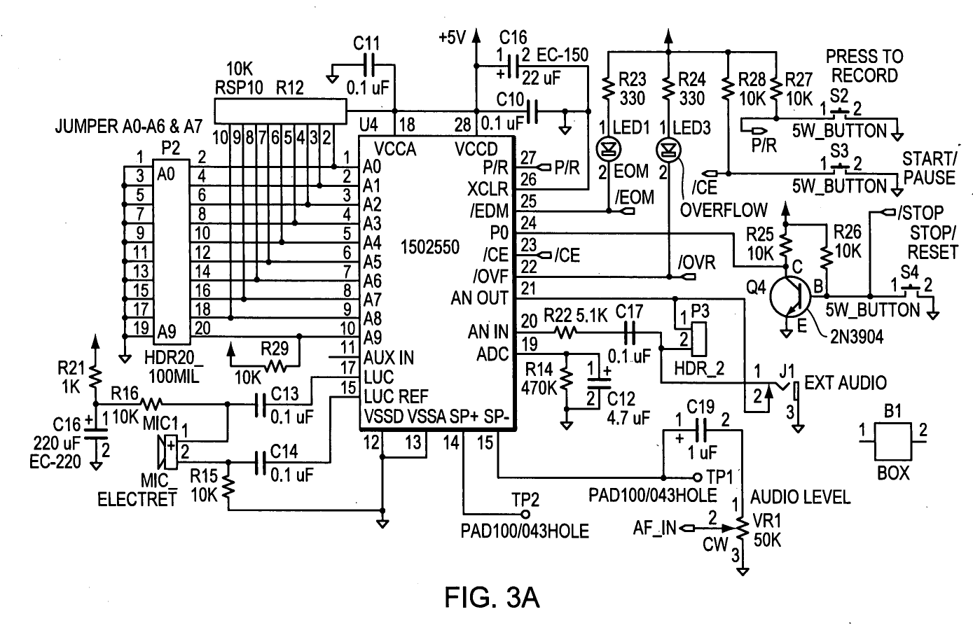

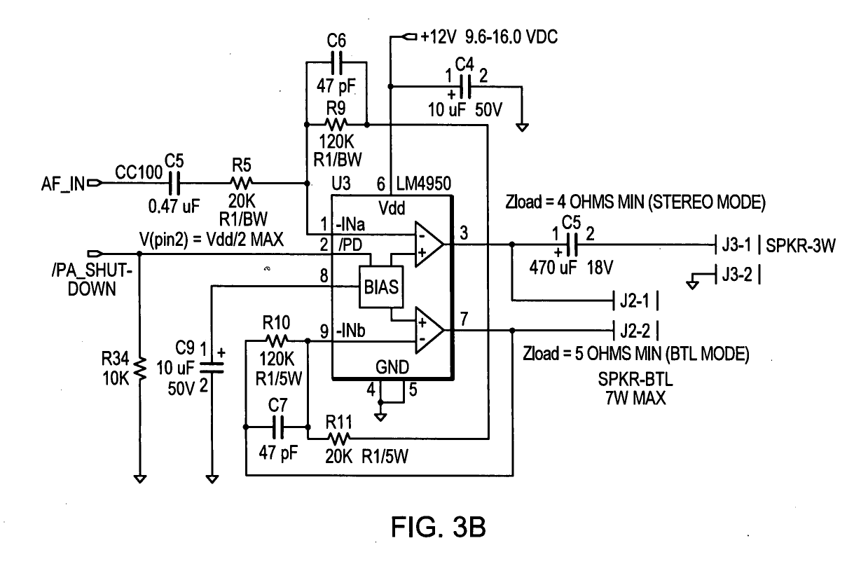

The system 11 of the invention is illustrated in greater detail in FIG. 1. More specifically, the components are connected at connection point 13 into the vehicle battery 25 and other electronics. Unnecessary components and other aspects of the vehicle's electrical system are not shown for ease of understanding since they are not necessary to be shown to understand the invention. The system 11 is preferably connected after the point (not shown) where the vehicle RF receiver receives signals from the owner's push button fob and before the vehicle horn or other sound generating system.

A central processing unit controlled digital audio storage unit 17 is connected to the power supply to be powered thereby. The storage unit 17 includes an amplifier and has at least one replaceable sound card 21 installed which provides multiple selectable audio sounds. Of course, as may be appreciated, since the card is replaceable, a user may customize the vehicle sound in accordance with user preference in the manner previously discussed.

This storage unit 17 is in turn connected to a speaker 19, mounted within the vehicle, preferably behind the grill to broadcast the replacement sound.

The digital audio storage unit 17 may also be connected to the lighting circuit, causing the storage unit 17 to activate when the lights blink in the locking/unlocking process.

FIGS. 2 and 3 show one embodiment of a specific circuit diagram for the storage unit 17 which is self explanatory to one of ordinary skill in the art from a viewing thereof. Thus, for the sake of brevity, the details thereof will not be discussed further herein. This circuit includes a section which serves to interrupt play of the vehicle's remote lock system's original sound and to have a selected sound played from the sound card 21. In addition, as will be evident from the Figures, the volume level from the selected sound can be adjusted by an operator. Similarly, specific sounds stored on the card can be selected by an operator on a case by case basis.

Thus, an electronic add-on package for an existing keyless entry system is provided. It allows the operator to change sounds when locking or unlocking the vehicle. A replacement fob can also be provided with separate buttons for different sounds as selected by the operator.

Since the sounds are stored on a chip or card, the user can select different responses. Examples of whimsical responses include:

Hunter version (e.g. duck call, deer call, turkey call, etc.);

Redneck version (e.g., “get 'er done”, duck, buck); or

Christmas tunes (e.g., Jingle Bells, “ho, ho, ho”, etc.).

While the invention has been described with respect to specific components and sounds, it will be appreciated that it is not limited to those specific components and comparable equivalents can be substituted so long as basic functionality is not changed, as will be readily apparent to those of ordinary skill.

What is claimed is:

1. An audio signaling device, comprising:
a loudspeaker and amplifier mountable and connectable to a vehicle's remote locking system;
a digital audio storage unit built into said loudspeaker and amplifier system, said digital audio storage unit having a replaceable storage module with at least one pre-recorded sound stored thereon, said predetermined sound being different from the sound emitted by the vehicle's remote locking system; and
interrupt means on said digital audio storage unit for preventing play of a vehicle's sound associated with its remote locking system when activated, and for ensuring play of the at least one pre-recorded sound.

2. The device of claim 1, wherein said digital audio storage unit is connectable to a vehicle's lighting system for causing a vehicle's lights to flash when the vehicle's remote locking system is activated.

3. The device of claim 1, wherein said digital audio storage unit includes a removable sound card having a plurality of sounds stored thereon, and further comprising selecting means for selecting a desired sound for play when a vehicle's remote locking system is activated.

4. The device of claim 3, wherein said sound card is programmable for adding or removing sounds stored thereon.

5. The device of claim 1, further comprising a volume control for controlling the output volume of said digital audio storage unit for said at least one pre-recorded sound.
